(19) United States
(12) Patent Application Publication
(10) Pub. No.: US 2011/0005473 A1
(43) Pub. Date: Jan. 13, 2011

(54) Hydrogen Supply Device and Hydrogen Supplying Method

(76) Inventors: Takao Ishikawa, Hitachi (JP); Hiroshi Kanemoto, Hitachi (JP); Masafumi Noujima, Hitachi (JP); Takeyuki Itabashi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/879,127

(22) Filed: Sep. 10, 2010

Related U.S. Application Data
(63) Continuation of application No. 11/354,998, filed on Feb. 16, 2006, now abandoned.

(30) Foreign Application Priority Data
Mar. 9, 2005 (JP) 2005-064764

(51) Int. Cl. F02B 43/10; F01N 3/10

(52) U.S. Cl. 123/3; 60/299

(57) ABSTRACT

A hydrogen supply device which generates hydrogen from hydrogen storing material which chemically stores hydrogen by a catalyst, wherein said device comprises valves on the fuel supply port and the exhaust port, and a valve controller which controls timing to opening and close the valves. Fuel supply pressure is 2 to 20 atm. Hydrogen generation pressure is 5 to 300 atm. Exhaust pressure is atmospheric pressure to 0.01 atm.

### CROSS-REFERENCE TO RELATED APPLICATION

This application is a continuation application of U.S. application Ser. No. 11/354,998, filed Feb. 16, 2006, the contents of which are incorporated herein by reference.

### CLAIM OF PRIORITY

This application claims priority from Japanese application Serial No. 2005-064764, filed on Mar. 9, 2005, the content of which is hereby incorporated by reference into this application.

### BACKGROUND OF THE INVENTION

1. Field of the Invention

This invention relates to a hydrogen supply device for supplying hydrogen to automobiles or distributed power supplies such as home fuel cells.

2. Related Art

From the viewpoint of preventing global warming due to the release of gases such as carbon dioxide, fossil-fuel is going to be outplaced by hydrogen which is expected as the third generation energy source. Further, to promote energy saving by using energy effectively and reducing the release of carbon dioxide, cogeneration of electric power facilities has been attracting public attention. Recently, fuel cell power generation systems which use hydrogen for power generation have been rapidly researched and developed to be used widely in various power generation fields such as power generation facilities for cars, homes, automatic vending machines, portable devices and so on. A fuel cell generates electricity and thermal energy simultaneously by reacting hydrogen and oxygen into water. These electric and thermal energies are used for hot-water supply and air-conditioning. So, a fuel cell is available as a distributed power supply for home use. Development of internal combustion engines such as micro-turbines and micro-engines besides fuel cells have also been under development.

However, hydrogen which is essential as a fuel is very hard to be handled in delivery, storage, and distribution. Hydrogen is a gas substance at ordinary temperature and harder to be handled in storage and delivery than liquid and solid materials. What is worse, hydrogen is combustible and may explode violently when it is mixed up with air at a preset ratio or higher.

To solve such problems, an organic hydride system which uses hydrocarbons such as cyclohexane and decarin has attracted a great deal of public attention as a hydrogen storage system which excels in safety, transportability, storage ability, and cost-reduction. These hydro carbons are liquid at ordinary temperature and easy to be transported.

For example, benzene and cyclohexane are cyclic hydrocarbons of the same number of carbons. However, benzene is an unsaturated hydrocarbon having double bonds of carbons but cyclohexane is a saturated hydrocarbon having no double bond. Cyclohexane is obtained by hydrogenation of benzene and benzene is obtained by dehydrogenation of cyclohexane. In other words, hydrogenation and dehydrogenation of hydrocarbon enable storage and supply of hydrogen.

There have been disclosed some hydrogen supply devices using organic hydrides which are hydrocarbons such as cyclohexane and decarin. For example, they are a method of spraying organic hydride directly over hot catalyst and a method of inserting a hydrogen separating tube into a cylindrical reactor to reduce the partial pressure of hydrogen, and cooling the reaction temperature. (Patent Document 1 and Non-patent Document 1)

Patent Document 1: Japanese Patent Publication 2002-184436

Non-patent Document 1: Applied Catalysis A: General 233, 91-102 (2002)

However, the above technologies also have problems. It is necessary to increase the efficiency of hydrogenation and dehydrogenation of cyclic hydrocarbons such as benzene and cyclohexane to put storage and supply of hydrogen to practical use.

Practically, dehydrogenation of organic hydride such as cyclohexane and decarin is carried out at a high temperature (e.g. 250° C. or higher). Part of electric energy generated by a fuel cell must be used to heat up the organic hydride. This will reduce the efficiency of power generation. Further, a large-scale facility is required by the method disclosed by Patent Document 1 which sprays cyclohexane over a hot catalyst layer through a sprayer to dehydrogenate it and cools the products (hydrogen and benzene) to separate as air and liquid. A conventional hydrogen supply device which uses cyclohexane as a hydrogen supplier intermittently sprays cyclohexane over a catalyst which is heated to about 300° C. When cyclohexane droplets touch the surface of the catalyst layer, cyclohexane evaporates. As the result, a complex interface of air, liquid, and solid is formed on the surface of the catalyst layer and hydrogen generates. Such a hydrogen supply device requires a lot of ancillary equipment such as a sprayer, a cylinder, and a cooler and cannot be down-sized. Further, since an electric heater is used to heat the catalyst, the overall power efficiency of a power generation system connected to a fuel cell will go down.

Meanwhile, when a hydrogen separating tube is used to cool the partial hydrogen pressure, the reaction speed goes down and the equipment must be greater although a high conversion rate is obtained at a temperature as low as about 200° C. The dehydrogenation of the organic hydride is an endothermic reaction. The equilibrium position of the dehydrogenation moves to the dehydrogenation side as the partial pressures of hydrogen and produced aromatic hydrocarbon become smaller at high temperature. Therefore, it is possible to get a high conversion rate even at low temperature by separating generated hydrogen by the hydrogen separating tube and reducing the partial pressure in the reaction gas. However, the reaction rate of the catalyst becomes smaller as the temperature goes down and the quantity of the catalyst must be increased to speed up the supply of organic hydride. This will make the reaction layer greater, requires more expensive hydrogen separating tubes, and pushes up the production cost.

### SUMMARY OF THE INVENTION

In view of the above problems, an object of this invention is to provide a high-efficient hydrogen supply device.

To attain the above object, a hydrogen supply device of this invention is a device for using a hydrogen storage material which chemically stores hydrogen and extracting hydrogen from the material by a catalyst, wherein the hydrogen supply device comprises valves for a fuel inlet and an exhaust outlet of the device and a valve control unit for controlling timing to open and close the valves;

the pressure in the hydrogen supply device varies in the range of 0.01 to 300 atm;

the fuel supply pressure is 2 to 20 atm, the hydrogen generation pressure is 5 to 300 atm, and the exhaust pressure is normal atmosphere to 0.01 atm; and

the fuel inlet valve and the exhaust outlet valve are controlled so that the device may receive fuel with the fuel inlet valve open and the exhaust outlet valve closed and may exhaust gas with the fuel inlet valve closed and the exhaust outlet valve open.

### BRIEF DESCRIPTION OF THE DRAWINGS

FIG. 1 shows the most basic schematic block diagram of the hydrogen supply device in accordance with this invention.

FIG. 2 shows one of the most basic valve control diagrams of the hydrogen supply system.

FIG. 3 shows a schematic illustration of a hydrogen storage/supply system for private power generation using reusable energies.

FIG. 4 shows the functional block diagram of a hydrogen supply device of Comparative Example 1.

FIG. 5 shows a functional block diagram of one of the most basic hydrogen system devices of this invention.

FIG. 6 shows a cross sectional view of a turbine type exhaust device.

FIG. 7 shows the schematic configuration of a hydrogen supply system using a hydrogen separation tube.

FIG. 8 shows sectional views of the hydrogen separation tube of the hydrogen supply device.

FIG. 9 shows a sectional view of the micro reactor of the hydrogen supply device.

FIG. 10 shows a sectional view of the micro reactor of the hydrogen supply device combined with a hydrogen separating membrane.

FIG. 11 shows the sectional view of a reciprocation type hydrogen supply device.

FIG. 12 shows a cycle of dehydrogenation of organic hydride and reactivation at high temperature.

FIG. 13 shows a schematic external view of a power generation system comprising a solid polymer type fuel cell and a hydrogen supply device of this invention.

FIG. 14 shows an operation flow of the power generation system combined with solid polymer fuel cell.

FIG. 15 shows the configuration of a tank which stores both fuel and waste liquid separately.

FIG. 16 shows an operation flow of a turbine-combined system of this embodiment.

FIG. 17 shows a sectional view of the hydrogen supply device unified with NOx removal catalyst of Embodiment 10.

FIG. 18 shows an operation flow of the hydrogen supply device unified with NOx removal catalyst.

### DETAILED DESCRIPTION OF THE PREFERRED EMBODIMENTS

According to one aspect of the present invention, there is provided a hydrogen supply device of this invention, which comprises,

a hydrogen supply device having a catalyst and a heater,

a valve timing control unit to control opening/closing timing of the valves provided on a fuel supply port and an exhaust port of the hydrogen supply device,

a booster pump for fuel supply, an exhaust pump for exhausting product gas from the hydrogen supply device,

a separator for separating hydrogen from a dehydrogenate,

a compressor for compressing generated hydrogen, and

a hydrogen tank for storing the generated hydrogen,

wherein the exhaust pump, the separator, and the compressor are built in an exhaust/separation/compression unit.

According to another aspect of the present invention, there is provided a hydrogen supply device of this invention provides a hydrogen separating membrane adjacent to a catalyst layer, separates generated hydrogen by means of the membrane, and collects hydrogen for recovery. The available catalyst is made of a metal catalyst and a carrier. The metal catalyst is at least one selected from a group of nickel, palladium, platinum, rhodium, iridium, ruthenium, molybdenum, rhenium, tungsten, vanadium, osmium, chromium, cobalt, and iron. The carrier is at least one selected from a group of alumina, zinc oxide, silica, zirconium oxide, diatomite, niobium oxide, vanadium oxide, activated carbon, zeolite, antimony oxide, titanium oxide, tungsten oxide, and iron oxide.

Another aspect of the present invention provides a hydrogen supply device of this invention provides a hydrogen separating membrane which forms a dehydrogenation catalyst a dehydrogenate catalyst on one side of the metal foil and a hydrogen channel on the other side. The hydrogen separating membrane mainly contains at least one of Zr, V, Nb, and Ta. The hydrogen storage materials available to this invention are one or more aromatic compounds selected from a group of benzene, toluene, xylene, mesitylene, naphthalene, methylnaphthalene, anthracene, biphenyl, phenancelene, and their alkyl substituents.

This invention provides a distributed power supply and an automobile comprising a hydrogen supply system and a generator selected from fuel cell, turbine and engine. The hydrogen supply device is used as a hydrogen engine which burns hydrogen since it can prevent overheating of the NOx purification catalyst by the endothermic reaction of the hydrogen supplying catalyst. The hydrogen supplying catalyst is provided on one part of a highly-thermal conductive substrate and the NOx purification catalyst is provided to the other part of the substrate. Zeolite-related catalyst is mainly used as the NOx purification catalyst.

Another aspect of the present invention provides a hydrogen supply device of this invention produces hydrogen by power generated by reusable energy and supplies hydrogen to a distributed power supply or car to drive thereof.

This invention can provide a high-efficiency hydrogen supply device which stores hydrogen and supplies it to a distributed power supply such as car or home fuel cell.

In the following, there will be explained a hydrogen supply device and system in accordance with this invention.

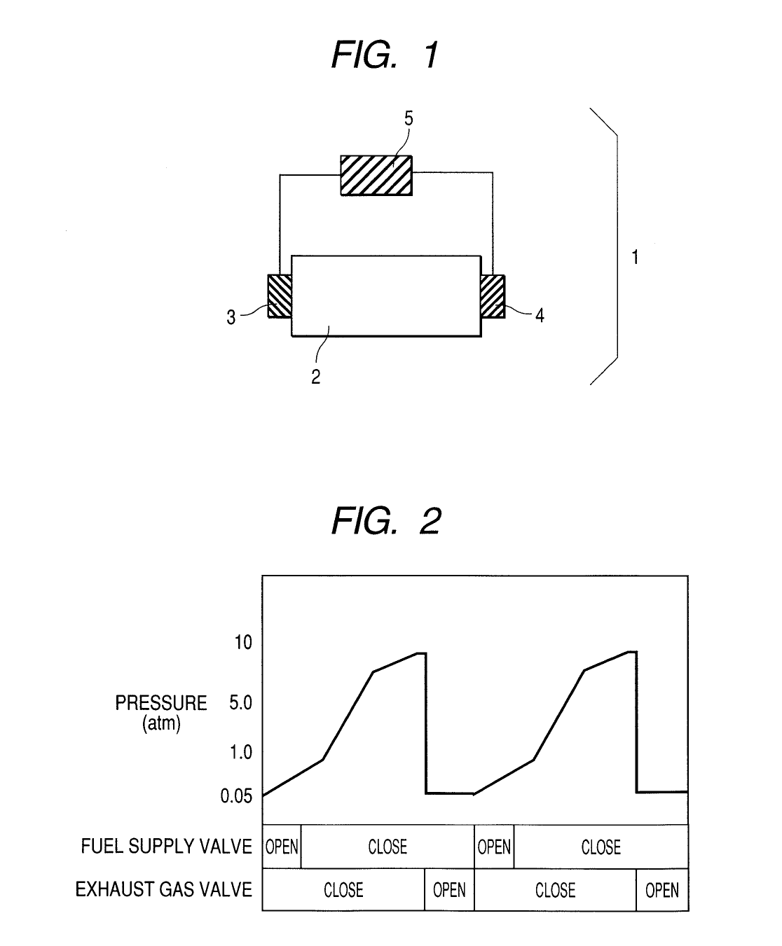

FIG. 1 shows the most basic schematic block diagram of the hydrogen supply device in accordance with this invention. Hydrogen supply device 1 comprises hydrogen supply unit 2, fuel supply valve 3, exhaust valve 4, and valve controller 5. Valve controller 5 controls timing to open and close fuel supply valve 3 and exhaust valve 4. Fuel supply valve 3 and exhaust valve 4 are electrically connected to valve controller 5. Hydrogen supply unit 2 will be explained later in detail. Fuel supply valve 3 and exhaust valve 4 can be of any type as long as they can be operated steadily for a specified period under operating temperature and pressure conditions. Also available are general-purpose valves (such as pneumatic valves and solenoid valves) and valves for car fuel supply.

In the following, there will be explained the valve open/close timing of the fuel supply valve and the exhaust valve.

FIG. 2 shows one of the most basic valve control diagrams. The valve controller controls the valves on the fuel inlet port and the exhaust port as follows

Opening the fuel supply valve and closing the exhaust valve to supply a preset quantity of fuel to the hydrogen supply device; closing the fuel supply valve, waiting until the internal pressure of the hydrogen supply device increases by generated hydrogen and the reaction is complete, opening the exhaust valve when the internal pressure of the hydrogen supply device increases by generating hydrogen so that the reaction is completed, and closing the exhaust valve after hydrogen in the hydrogen supply device is exhausted. These steps are repeated. The valve controller uses sensors provided in the hydrogen supply device to control valve operations. For example, in the case of a pressure sensor, the valve controller closes the exhaust valve based on the internal pressure of the hydrogen supply device, and opens the fuel supply valve to let fuel come into the hydrogen supply device. Further, when the reaction is completed and the internal pressure is stable, the valve controller opens the exhaust valve. The valve controller can also control timing to open and control valves by monitoring temperature changes by a temperature sensor or changes in thermal conductivity of gas by a thermal conductivity detector (TCD which is used for gas chromatography). Since evaporation of fuel and dehydrogenation are endothermic reactions, temperature of the hydrogen supply device slightly drops. After the reaction is completed, the temperature rises because of no endothermic reaction. The temperature sensors monitor these temperature changes and send signals to the valve controller. A temperature controlling using the TCD uses a change in thermal conductivity due to a change in gas components. Hydrogen is lower in thermal conductivity than fuel and dehydrogenates. Therefore, when the partial pressure of hydrogen increases after the reaction is complete or when the gas pressure in the hydrogen supply device reduces by exhausting, the thermal conductivity of gases in the device reduces. Signals of changes in thermal conductivity are sent to the valve controller to control timing to open and close the valves.

The fuel supply pressure can be some atmospheric pressures to some hundred atmospheric pressures. The gas in the hydrogen supply device can be exhausted naturally (through the exhaust valve) or forcibly by an air pump, turbo pump, or vacuum pump. Usually, it is preferable that the fuel supply pressure, hydrogen generation pressure, and exhaust pressure are respectively 2 to 20 atm, 5 to 300 atm, and atmospheric pressure to 0.01 atm in this order. The internal pressure of the hydrogen supply device varies 0.01 to 300 atm depending upon the operating status (fuel supply and gas exhausting).

The interval of intermittent (or pulsating) fuel supply is not specifically limited. It is optimized depending upon reaction temperature and pressure conditions. Fuel can be injected continuously or intermittently until the conversion rate reduces to some extent.

This invention basically controls the operation timing of the fuel inlet valve and the exhaust outlet valve to open the fuel inlet valve and close the exhaust outlet valve when supplying fuel to the hydrogen supply device,

to close both the fuel inlet valve and the exhaust outlet valve when hydrogen is generated, and

to close the fuel inlet valve and open the exhaust outlet valve when exhausting gas from the hydrogen supply device. However, this invention is not limited to this.

It is also possible to adopt the following steps:

opening both the fuel inlet valve and the exhaust outlet valve until the conversion rate reduces to some extent,

advancing the continuous reaction in the circulation system,

closing both the fuel inlet valve and the exhaust outlet valve when the conversion rate reaches a preset value, and

opening the exhaust valve which is connected to a vacuum pump to evacuate the hydrogen supply device for reactivation. The valve controlling brings about a great pressure change in reactivation of the system. The system need not be reactivated in a short time and it is possible to return the system to the continuous reaction of the circulation system after reactivation. In other words, it is possible to use a controlling method which combines valve timing control and continuous reaction of the circulation system. In some cases, the reactivation requires about 10 minutes but it depends upon temperature and pressure. Usually, it is 30 seconds or less. It can be a few seconds if the continuous reaction of the circulation system is not included.

It is also possible to control the time of dehydrogenation in the hydrogen supply device after injection of fuel. It is possible to carry out exhausting and reactivation simultaneously by closing both the fuel supply valve and the exhaust valve until dehydrogenation reaction of the supplied fuel is completed and opening the exhaust valve at the end of the dehydrogenation.

There are two valve timing control methods: controlling valves by their specified timing patterns and controlling valves by feeding back sensor signals. In time controlling, the characteristics of catalysts and reaction temperature, pressures, etc are investigated to obtain a sequence program in advance, the valve controlling device is operated in accordance with the sequence program. The valve controlling method by feedback of sensor signals uses various sensors such as pressure sensor, temperature sensor, flow-rate sensor, and hydrogen sensor, receives signals from the sensors, calculates the conversion rate of the reaction, and sends signals directly to operate the valves to minimize the change in the conversion rate.

The dehydrogenation of organic hydride is thermodynamically restricted and the conversion rate of the normal reaction is the equilibrium conversion rate which is thermodynamically calculated. To increase the efficiency of extracting hydrogen from organic hydride, the dehydrogenation must be kept at a preset low temperature. However, in this case, it is difficult to increase the conversion rate because of a thermo dynamical restriction. After thorough research and study, the inventors found that the conversion rate of the dehydrogenation at a temperature of 250° C. or lower is initially very high (when fuel is intermittently injected over the catalyst) but decreases down to the equilibrium conversion rate as the shots of fuel increases.

After further consideration, the inventors found that the catalyst of the equilibrium conversion rate can be reactivated by heating it to a high temperature or degassing it in a vacuum state. In the early stage of the reaction, catalyst surfaces are very active and show a high conversion rate. However, as the reaction proceeds, aromatic hydrocarbons (which are dehydrogenates) are adsorbed to the surface of the catalyst and the dehydrogenation becomes balanced with the hydrogenation. When the reaction is balanced, the conversion rate of the reaction is equal to the equilibrium conversion rate. When heated or degassed, the catalyst separates dehydrogenates from its surface and recovers the initial high activity. Naturally, the conversion rate of the reactivated catalyst is very high.

The catalyst reactivation by heating or vacuum-degassing can be carried out under any condition as long as the dehydrogenate can be removed from catalyst surfaces. For example, the catalyst reactivating condition can be 300° C. or lower and about 0.5 atm when the catalyst material can separate dehydrogenates easily but 400° C. and about 0.1 atm when the catalyst material is hard to separate dehydrogenates.

The hydrogen supply device of this invention is a reactor and a system which continuously reactivates catalysts by heating or vacuum-degassing using the above properties and assures high conversion rates even at low temperature. As described above, the hydrogen supply device of this invention unlike conventional hydrogen supply devices enables catalyst reactivation using pressure changes or catalyst reactivation by heating. By such a catalyst reactivation, the hydrogen supply device of this invention efficiently extracts hydrogen from organic hydrides even at low temperature and supplies hydrogen to hydrogen-requiring units such as a fuel cell and an engine.

Various auxiliary units are connected to the hydrogen supply device of this invention and explained below.

Auxiliary units connected to the hydrogen supply device of this invention which contains catalyst and a heater are:

a valve timing control unit for controlling timing to open and close valves provided on a fuel supply port and an exhaust port of the hydrogen supply device,

a booster pump for fuel supply,

an exhaust pump for exhausting product gas from the hydrogen supply device,

a separator for separating hydrogen from dehydrogenate,

a compressor for compressing generated hydrogen, and

a hydrogen tank for storage of generated hydrogen.

The valve timing control unit can be any unit as long as it can process parameters such as time, temperature, pressure, and thermal conductivity. For example, such units are a valve timing control device and circuit for automobile, a device and circuit for controlling an exhaust system such as a vacuum unit, etc.

The booster pump for fuel supply can be of any type (plunger type or piston type) as long as it can pressure-deliver liquid fuel. For example, it can be a fuel supply pump for automobile or a liquid pump for liquid chromatography which is available commercially.

The exhaust pump can be of any type (piston type or turbine type) as long as it can suck gases. For example, it can be an air pump, a vacuum pump, a micro turbine, or a supercharging turbine for automobile which is available commercially. Usually these pumps are driven by electric power but can be driven by exhaust gas from a fuel cell or engine. When an engine pump is used, the pump can be driven directly by the power of the engine. When the hydrogen supply device is mounted on a car, the pump can be driven by the power of an axle of the car. The separator uses air- or water-cooling to separate hydrogen (gas) and dehydrogenate (liquid) from each other. A cooling unit combined with a compressor or an electric means using the Peltier effect can be used for gas-liquid separation by cooling. Further, it is possible to use fuel instead of the cooling water to cool the gas-liquid mixture and pre-heat the fuel simultaneously (just like a heat exchange). This kind of separator is not required when a hydrogen separating membrane is used to directly separate hydrogen in the hydrogen supply device.

The hydrogen supply device of this invention can be of any type (straight tube type, piston type, or micro reactor type). The hydrogen supply device basically comprises a highly-thermal conductive substrate and a catalyst layer, but can contain a hydrogen separation membrane in some cases. Independently of the device type (straight tube type, piston type, or micro reactor type), the hydrogen supply device have the same materials. The materials are explained below.

The highly-thermal conductive substrate can be made of ceramics such as aluminum nitride, silicon nitride, alumina, mullite, etc., carbon materials such as graphite sheet, etc., metals such as copper, nickel, aluminum, silicon, titanium, zirconium, niobium, and vanadium) or metal alloy. The highly-thermal conductive substrate should be thinner and have a greater thermal conductivity to quickly transfer heat to the catalyst layer and heat the catalyst layer efficiently without causing a temperature drop even in the endothermic reaction.

Next will be explained the catalyst. The catalyst is made of a metal catalyst and a carrier. The metal catalyst is at least one selected from a group of Ni, Pd, Pt, Rh, Ir, Re, Ru, Mo, W, V, Os, Cr, Co, Fe, and alloy of these metals. The carrier is at least one selected from a group of activated carbon, carbon nano-tube, silica, alumina, aluminum silicate (e.g., zeolite), zinc oxide, zirconium oxide, diatomite, niobium oxide, vanadium oxide, and so on.

The catalyst material can be prepared by any method such as a coprecipitation method or thermal decomposition method. The catalyst layer can be formed by a solution process such as a sol-gel process or a dry process such as a CVD process. To use a metal such as aluminum, zirconium, niobium, or vanadium for the highly-thermal conductive substrate, it is possible to anodize the metal and form the oxide carrier directly on the surface of the metal.

The hydrogen separation membrane is made of heat-resistant polymers such as porous polyimide, etc, alumino-silicate such as zeolite, etc, oxides such as silica, zirconia, or alumina, etc, metal alloys of Pd, Nb, Zr, V, or Ta. Nb and V foils are preferable. It is possible to use alloys of Nb or V with Mo, Co, or Ni.

The hydrogen separation membrane can be produced by a film-forming method such as a solution process, a vapor deposition process, and a sputtering process. The solution process is further divided into a dipping process, a spin-coating process, and a spraying process. The hydrogen separation membrane is formed by coating by any of these processes. The coating liquid can be a liquid, which contains dispersed particles. A metallic hydrogen separation membrane can be formed by a plating method such as electroless plating or electroplating method.

The hydrogen separation membrane, when made of porous polyimide, can have a skin layer on one side of the membrane and a porous polyimide layer containing voids or sponge-like cavities on the other side.

To increase the hydrogen separating efficiency, the catalyst material and the hydrogen separation membrane should preferably be adjacent to each other and more preferably be combined in a body. Porous membranes and metal foil membranes are available for hydrogen separation membranes unified with catalyst. The metal foil membrane comprises a metallic foil for separation of hydrogen which is a metallic foil of zirconium, niobium, vanadium or alloy thereof and a catalyst carrier of anodized metal (oxide) which is formed on the metallic foil.

The porous hydrogen separation membrane can hold catalyst in voids of the porous membrane made of alumina, zeolite, or porous polyimide. The hydrogen separating membrane can be formed on one side of the porous material by sputtering or plating.

The hydrogen storage and supply devices can be fabricated by laminating the above members into a large sheet of devices and cutting the sheet into small pieces of devices.

It is possible to use a catalyst carrier unified with the hydrogen separation membrane. For example, a clad catalyst carrier comprises metal alloy cores (Ni—Zr—Nb alloy) coated with a Nb layer. The Ni—Zr—Nb alloy membrane is more resistant to hydrogen embrittlement than a single metal membrane (Zr or Nb only) and has a good hydrogen permeability. The catalyst carrier unified with the hydrogen separation membrane can be fabricated by anodizing the Nb layer on the surface of the carrier material and adding Pt to the niobium oxide layer. It is more preferable to form a palladium layer selectively on the surface of the Ni—Zr—Nb layer by electro plating after anodizing since this accelerates association and dissociation of hydrogen molecules on the surface of the hydrogen separation membrane and increases the speed of hydrogen permeability.

The above core materials can be palladium or palladium alloys such as Pd, Pd—Ag, Pd—Y, Pd—Y—Ag, Pd—Au, Pd—Cu, Pd—B, Pd—Ni, Pd—Ru, and Pd—Ce, and non-palladium alloys such as Ni—Zr, Ni—Nb, Ni—Zr—Nb, Ni—V, and Ni—Ta. The above hydrogen separating membranes can be prepared by a rolling process, solution process, vapor deposition process, sputtering process, or plating process (e.g., electroless plating and electroplating).

Metals available for the metal layer formed on the surface of the core are anodizable metals such as Al, Nb, Ta, Zr, Zn, Ti, Y, and Mg. The metal layer can be formed on the surface of the core material by junction, non-aqueous plating, pressure-bonding, sputtering, or dipping.

The anodizing method uses various kinds of electrolytic solution to oxidize metals. The electrolytic solutions are aqueous acid solutions such as phosphoric acid, chromic acid, oxalic acid, and sulfuric acid, aqueous alkaline solutions such as sodium hydroxide and potassium hydroxide, and aqueous neutral solutions such as boric-sodium borate, ammonium tartrate, and ethyleneglycol-ammonium borate. There are three kinds of oxide layers formed by anodizing: porous layer, barrier layer and a mixture of porous and barrier layers. For formation of a porous layer, void sizes and thickness of the porous layer can be determined properly depending upon applied voltage, anodizing solution temperature, anodizing time, and so on. It is preferable that the void sizes are 10 nm to 2 μm and layer thickness is 10 nm to 300 μm.

The temperature of the anodizing solution should preferably be 0 to 80° C. The anodizing time is dependent upon the anodizing condition and thickness of a layer to be formed. For example, a porous niobium oxide layer having a void size of 1 μm and a thickness of 2 μm can be formed by anodizing niobium by an aqueous solution of sodium hydroxide (1 to 40 grams per liter) at a solution temperature of 30° C. and a voltage of 100 V for 2 hour.

For formation of a barrier layer, for example, a niobium type catalyst unified with a hydrogen separating membrane can be prepared by anodizing niobium, hydrating and burning the niobium oxide film to generate cracks in the film, and adding platinum to the film. It is more preferable to form a palladium layer selectively on the surface of the hydrogen separation membrane by electro plating after anodizing since this accelerates association and dissociation of hydrogen molecules on the surface of the hydrogen separation membrane and increases the speed of hydrogen permeability. The hydration is carried out in water of pH 6 or preferably pH 7 or more at 50 to 200° C. The hydrating time is dependent upon pH of the solution and the hydrating temperature, but it should preferably be 5 minutes or longer. The niobium oxide film is burned at 300 to 550° C. for 0.5 to 5 hours.

In any case of layer formation (formation of a barrier layer and formation of both porous and barrier layers), core materials are locally exposed from the ground and hydrogen produced by the dehydrogenation is separated out of the reaction system through the exposed areas. This can increase the efficiency of dehydrogenation.

Similar catalysts unified with a hydrogen separating membrane can be prepared by combining the other core materials and the other metallic layers which have been described above.

The peripheries of the hydrogen storage and supply device must be sealed. Any sealing material (metal, ceramics, glass, or plastic material) can be used as long as it can prevent hydrogen and raw materials from leaking out of the device. The device is sealed up by a coating or melting method. Further, it is also possible to solder the peripheries of the device by a reflow method (when using a soldering material which is used for production of printed circuit boards).

The hydrogen supply device can be of any type (straight tube type, piston type, or micro reactor type). However, material shapes and catalyst reactivation methods are dependent upon device types and will be explained in detail below.

As for a straight tube type hydrogen supply device, it is possible to fill up the tube inside directly with catalyst powder, to place honeycomb-shaped catalyst elements in the tube, or to form a catalyst layer directly on the inner wall of the tube. When a hydrogen separation membrane is used, a hydrogen separation tube is placed in the reaction tube. A catalyst layer can be formed directly on the outer surface of the hydrogen separation tube.

The piston type hydrogen supply device comprises a cylinder having a fuel inlet valve and an exhaust valve and a piston whose surface is coated with catalyst. This type of hydrogen supply device can heat up the catalyst by a heater. It is also possible to heat up the catalyst and gas in the reaction layer by closing the valves and adiabatically compress the gas in the hydrogen supply device.

When the catalyst layer is made of a material such as activated carbon or zeolite which selectively adsorbs hydrocarbons, it is possible to separate hydrogen and dehydrogenates from each other in the hydrogen supply device by injecting fuel into the device, dehydrogenating fuel at 300° C. or lower, letting the dehydrogenate absorbed by the catalyst layer, opening the exhaust valve to discharge hydrogen gas only, closing the exhaust valve, compressing thereof adiabatically, heating thereof to 400° C. or higher to separate the dehydrogenate from the catalyst, and opening the exhaust valve to discharge the dehydrogenate. The separation method is not limited to the above method of adsorbing the dehydrogenate. It can be a method of causing the catalyst layer to adsorb or store hydrogen. In other words, the catalyst layer can be made of a material which can adsorb or store hydrogen (e.g., hydrogen storage alloy) to separate hydrogen by adsorption.

Next will be explained a micro-reactor type hydrogen supply device. The micro-reactor comprises an assembly of a highly-thermal conductive substrate, a catalyst layer, a hydrogen separation unit, a highly-thermal conductive substrate, fuel channel, a catalyst layer, a hydrogen separation unit, and a spacer. This assembly is wholly enclosed air-tight. Respective micro-reactor members will be explained in detail below.

The highly-thermal conductive substrate has fuel channels on its surface. The fuel channel can have multiple fuel inlets and outlets whose numbers are not limited as long as fuel can be supplied adequately. Fuel channels, inlets, and outlets can be formed on the highly-thermal conductive substrate by machine-working (e.g., cutting or pressing), etching (for production of finer patterns), plating, or soft-lithography (e.g., nano-imprinting). Dry processes such as vapor deposition and sputtering methods are also available.

Next will be explained the catalyst layer. The catalyst layer is formed directly over the fuel channels or on the hydrogen separating membrane.

The spacer works as a layer to flow generated hydrogen gas when it is used for the hydrogen supply device or as a hydrogen supply port when it is used for the hydrogen storage device. The spacer can have grooves on the surface or through-holes which are formed perpendicularly to the spacer surfaces. The spacer has a hydrogen separating membrane on one side (surface) of the spacer. The hydrogen separation membrane can be formed on the spacer by any method, but it is effective to first form the hydrogen separation membrane on a porous membrane and then attach the membrane to the spacer. The porous material can be ceramics substrate materials (such as silica, alumina, and alumino-silicate (e.g., zeolite)), metal-mesh laminate materials, fiber-reinforced materials (carbon, glass, or alumina fibers), and heat-resistant polymer materials (fluorine resin and polyimide resin).

The micro-reactor type hydrogen supply device is sealed with glass, resin, or metal material. The metallic parts of the hydrogen supply device can be directly sealed by a diffusion bonding or brazing method.

The hydrogen storage material used by this invention is an aromatic compound which contains one or more selected from a group of benzene, toluene, xylene, mesitylene, naphthalene, methylnaphthalene, anthracene, biphenyl, phenancelene, and their alkyl substituents. The oxygen and hydrogen storage materials used as fuel can be aqueous ammonium solution, aqueous hydrazine solution, or a mixture of hydrogen peroxide solution and sodium borate, ammonia, or hydrazine solution.

Next will be explained a fuel cell power system and a hydrogen combustion system which respectively use the hydrogen supply system of this invention. Any type of fuel cell can be used or power generation. It can be a solid polymer type, phosphate type, or alkaline type. The fuel cell is connected to the hydrogen supply system of this invention for power generation. The hydrogen supply system receives fuel, controls valves, produces hydrogen at high efficiency, and causes the exhaust pump to suck hydrogen from the hydrogen supply device and send hydrogen to the fuel cell. In this case, an auxiliary tank is provided in the exit of the exhaust pump to store high pressure hydrogen (some atmospheres to some ten atmospheres). Since the hydrogen supply device controls valves intermittently, hydrogen is generated also intermittently (in a pulsating manner). This tank can supply hydrogen steadily and continuously to the fuel cell and further enables immediate start-up of the fuel cell. Therefore, this makes the fuel cell power system available to a stationary power generator and automobile.

In order to increase the efficiency of a power generation system which uses a fuel cell, the hydrogen supply system of this invention is unified with a fuel cell to be compact. This also enables the device to use the waste heat of the fuel cell. Further, the hydrogen supply system can recover heat from hot dehydrogenate which is drawn from the hydrogen supply device. This can increase the efficiency. The hot dehydrogenate drawn from the hydrogen supply device is sent to a heat exchange provided on the fuel supply section and preheat fuel. Further, the exhaust gas from the fuel cell has an exhaust pressure and the pressure is reused to run the exhaust pump on the hydrogen supply system. In this way, an energy recovery system is provided to use the waste heat of the fuel cell and the exhaust gas o increase the efficiency of the system.

Next will be explained the hydrogen supply system applied to an engine. This hydrogen supply system is the same as the hydrogen supply system applied to a fuel cell (in the use of an auxiliary tank, exhaust gas, and exhaust heat, and recovery of thermal energy of dehydrogenates). The exhaust gas from the engine is hotter than that from the fuel cell. If the heat of the exhaust gas from the engine is used directly, the heater of the hydrogen supply device can be used initially only. One of the greatest differences between the hydrogen supply system applied to an engine and the hydrogen supply system applied to a fuel cell is the purity of hydrogen gas from the hydrogen supply device.

The purity of hydrogen gas for the engine, which combusts hydrogen needs not to be so high, although the fuel cell requires high-purity hydrogen gas. In other words, the hydrogen gas for the engine can contain a little hydrocarbons and the engine can burn the hydrocarbons. In some cases, a small amount of hydrocarbons in the hydrogen gas will make controlling easier comparatively. Therefore, when dehydrogenates are removed from the hydrogen gas which is discharged from the hydrogen supply device, the hydrogen gas can contain a little hydrocarbons. Although the hydrogen gas pumped out from the hydrogen supply device contains dehydrogenates equivalent to the vapor pressure, the engine can burn the gas normally. Therefore, the hydrogen supply system applied to the engine can be more simplified. Meanwhile, the engine exhaust contains thermal NOx due to combustion of air and fuel and this system must be equipped with an NOx removal means such as a car EGR (short for Exhaust Gas Recirculation) system or proper catalysts.

Since the hydrogen engine is of a lean-burn type, the lean-burn type NOx removal catalyst and zeolite-based NOx removal catalyst are available. However, the zeolite-based catalyst is preferably equipped with a cooling unit since the catalyst becomes deactivated at 500° C. or higher. This cooling unit can utilize the endothermic property of the dehydrogenation. In other words, the hydrogen supply device for the hydrogen supply system of this invention can be unified with a NOx removal function. Specifically, by connecting a dehydrogenate combustion gas line of the hydrogen supply device to the exhaust gas line of the engine and coating the line with the zeolite-based NOx removal catalyst, it is possible to remove NOx from the exhaust gas and heat the catalyst layer of the hydrogen supply device simultaneously.

Further, as the dehydrogenation proceeds, the hot exhaust gas is cooled. Consequently, this invention can keep the reaction temperature of the hydrogen supply device 500° C. or lower and use the high-performance zeolite-based NOx removal catalyst.

In the following, there will be explained some hydrogen storage/supply devices and systems as examples in accordance with the above members and fabricating methods.

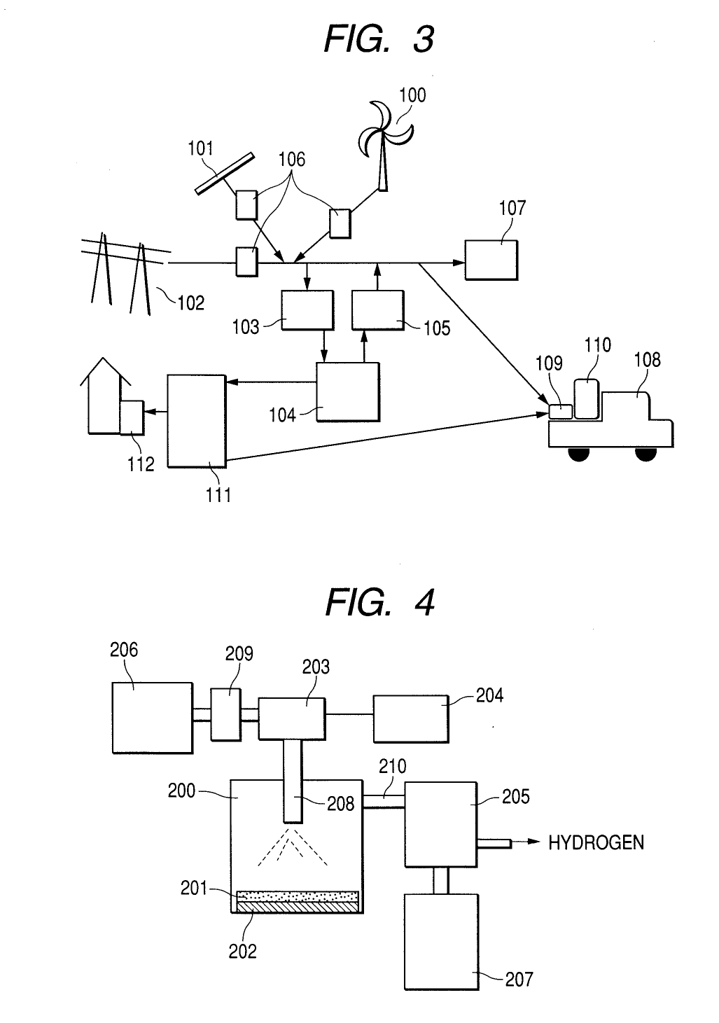

FIG. 3 shows a schematic illustration of a hydrogen energy community which contains a distributed power supply and a hydrogen-fueled car which use system power and reusable energy of wind and solar energies. The hydrogen supply/storage device of this invention works as part of this system. The hydrogen energy community contains wind-power generator 100, solar cell power generator 101, system power 102, water electrolyzing equipment 103, hydrogen supply/storage device 104, fuel cell system 105, hydride station 111, and home distributed power supply 112. Car 108 is equipped with hydrogen storage/supply device 109, fuel cell system or hydrogen engine system 110. For example, electricity generated by a reusable energy generator such as solar cell 101 is converted into alternating current through inverter 106. The converted electricity is supplied to home appliance 107 or to water electrolyzing equipment 103 when the generated electricity is excess. Water electrolyzing equipment 103 electrolyzes water into hydrogen and oxygen. Generated hydrogen is sent to hydrogen storage/supply device 109 and used there to hydrogenate the waste liquid which is an aromatic compound dehydrogenated by hydrogen supply/storage device 104.

Usually power demands are classified into two: peak demand due to the greatest loads in the daytime and basic demand due to normal loads independent of load changes in the daytime and the night time. The power generation system in FIG. 3 supplies power for peak demands due to the greatest loads in the daytime. The base power is supplied from system power 102 of a power company or the like. For CO₂ reduction, it is preferable that the system power 102 should also use re-usable energies. The reusable energies are solar, wind, geothermal, ocean, tidal, and biomass energies. The solar energy is available only while the sun is shining but the other reusable energies are available all day long. Usually, the power demand in the night time is much less than that in the daytime. So, heating power stations temporarily stop in the night time to save fuels. Meanwhile, power stations using reusable energies which are very inexpensive can generate and supply electric power even in the night time. However, the electric demand in the night time is very little and surplus electric power is used for production of hydrogen. Specifically, this surplus electric power is used to electrolyze water into hydrogen and oxygen. Produced hydrogen is reacted into organic hydride by hydrogen supply/storage device 104 of this invention and stored in hydride station 111. Hydrogen extracted from organic hydride is sent as fuel to distributed power supply 112 and car 108 in FIG. 3. Electric power generated by the reusable energies is supplied as electric power for peak demand in the daytime. Any surplus electric power is used to electrolyze water into hydrogen and oxygen. Produced hydrogen is reacted into organic hydride by hydrogen supply/storage device 104, 109 of this invention and stored in hydride station 111.

On car 108, hydrogen storage/supply device 109 reproduces hydrogen from organic hydride and supplies hydrogen to fuel cell system or hydrogen engine system 110. When connected to electrolyzing equipment 103, car 108 as well as the home distributed power supply can reproduce the waste liquid in the car by hydrogen storage/supply device 109 in the night time.

### Comparative Example 1

FIG. 4 shows the functional block diagram of a hydrogen supply device of Comparative Example 1. Cylindrical reactor 200 comprises catalyst 201, heater 202, and fuel supply port 208. Fuel supply valve 203, valve control unit 204, booster pump 209, and fuel tank 206 are connected to fuel supply port 208. The fuel supplied through fuel supply port 208 reacts with catalyst 201 in cylindrical reactor 200 into hydrogen and dehydrogenates. The gas in the cylindrical reactor (containing hydrogen, dehydrogenates, and unreacted fuel) is sent to cooling unit 205 through exhaust port 210 and separated into hydrogen (gas) and hydrocarbons (liquid). The hydrocarbons are stored in waste liquid tank 207 and hydrogen is sent to the outside of the hydrogen supply device.

This hydrogen supply device dehydrogenates methylcyclohxane by aluminum catalyst which carries platinum at 250° C. The resulting conversion rate is 30% which is close to the equilibrium conversion rate of methylcyclohxane which is thermodynamically calculated. Although the dehydrogenations were made under various conditions, the resulting conversion rate could not exceed the equilibrium conversion rate of methylcyclohxane.

### Embodiment 1

The catalyst for dehydrogenating organic hydride is made of a metal catalyst and a carrier material. Specifically, this Embodiment shows the result of consideration of carrier materials.

### (Carrier Materials)

The inventors used activated carbons, Al₂O₃, ZrO₂, Nb₂O₅, V₂O₅, and SnO₂ as carrier materials. Materials except for Al₂O₂ are commercially available (e.g. fabricated by Kojundo Chemical Lab. Co., Ltd.) and activated carbons are Vulcan (fabricated by Cabot Corp.)

The inventors prepared Al₂O₃ by dissolving 20 grams of aluminum isopropoxide (fabricated by Wako Pure Chemical Industries, Ltd.) into 80 grams of hot water at 80° C., titrating nitric acid (5 ml) into the solution to gelate thereof, and drying the gel at 120° C. for 5 hours and then at 450° C. for 2 hours. The inventors prepared composite carrier materials as follows:

The inventors prepared Al₂O₂-based composite oxide (2% by weight of Nb₂O₅—Al₂O₃ and 2% by weight of ZrO₂—Al₂O₃) by mixing a specified quantity of aqueous zirconyl nitrate solution and a specified quantity of alcohol solution of niobium ethoxide, impregnating the carrier material with the solution, drying thereof at 120° C. for 5 hours and then at 450° C. for 2 hours.

The inventors prepared V₂O₅-based composite oxide (2% by weight of ZrO₂—V₂O₅ and 2% by weight of WO₃—V₂O₅) by mixing a specified quantity of aqueous zirconyl nitrate solution and a specified quantity of aqueous ammonium tungstate solution, impregnating the carrier material with the solution, drying thereof at 120° C. for 5 hours and then at 450° C. for 2 hours.

### (Metallic Catalyst Carrier)

4% by weight of colloidal platinum (2 nm, fabricated by Tanaka Kikinzoku Kogyo) was used as the metal catalyst. The platinum catalyst carrier was prepared by weighing colloidal platinum and carrier material so that 5% by weight of platinum may be carried by the catalyst, diluting colloidal platinum with methoxyethanol, impregnating the carrier material with the solution, drying thereof at 80° C. for 20 minutes and then at 400° C. for 2 hours in the helium gas.

### (Evaluation of Catalyst Performance)

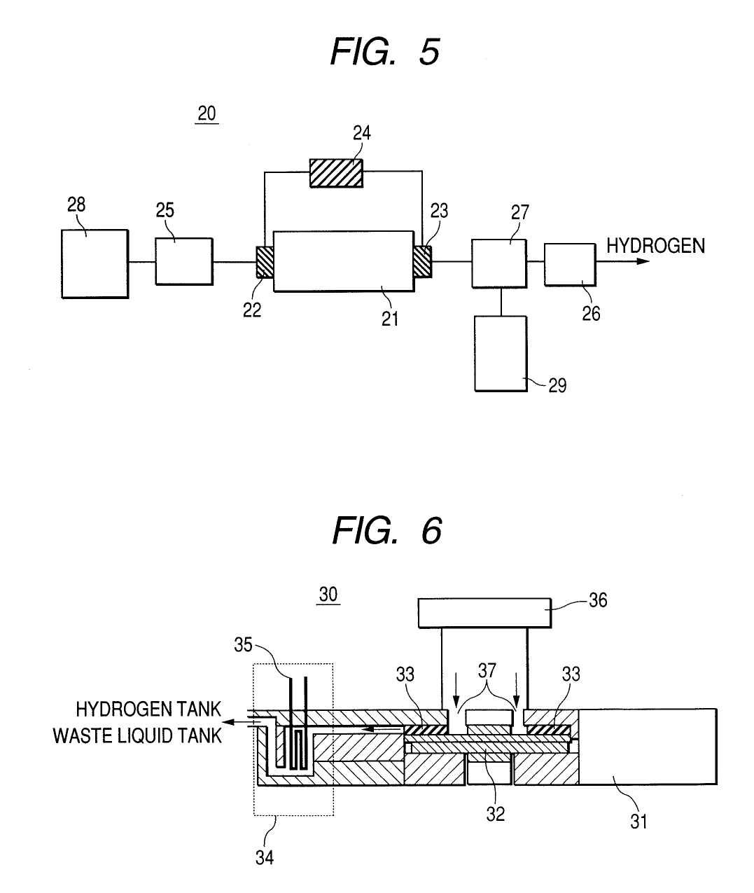

FIG. 5 shows a functional block diagram of one of the most basic hydrogen system devices of this invention. Hydrogen supply system 20 comprises hydrogen supply device 21, fuel supply valve 22, exhaust valve 23, valve controller 24, and auxiliary units (booster pump 25, exhaust pump 26, cooler 27, fuel tank 28, and dehydrogenate storage tank 29). In this embodiment, hydrogen supply system 20 is made of a ¼-inch stainless-steel reactor tube. Hydrogen supply device 21 is filled with catalyst powder and equipped with a heater on the outer periphery to heat the catalyst. The inventors used methylcyclohexane as organic hydride and measure the rate of conversion from methylcyclohexane to toluene.

The inventors evaluated the activity of the circulation system by loading hydrogen supply device 21 with 0.3 gram of platinum-carrying catalyst and continuously flowing helium at 10 ml/min and methylcyclohexane at 100 μl/min at 250° C. Meanwhile, the inventors evaluated the catalyst activation in a vacuum state by repeating hydrogenation and pressure reduction, specifically, by repeating fuel supply (at a fuel supply pressure of 10 atm) and gas exhaust (at an exhaust pressure of 0.05 atm) every second through the inlet and outlet valves on the reactor tube. Also while the valves were controlled, methylcyclohexane (at a rate of 100 μl/min) was intermittently injected at 250° C.

The inventors measured the peak area of methylcyclohexane (98) and the peak area of toluene (92) and calculate the conversion rate (from methylcyclohexane to toluene) by gas chromatography GC-mass (GC-6500 by Simadzu Corp.). Table 1 lists the results.

TABLE 1

| | Conversion rate of | Conversion rate |
|---|---|---|
| | the circulation | after |
| Carrier material | system (%) | reactivation(%) |
| Activated carbon | 20 | 65 |
| Al₂O₃ | 32 | 66 |
| ZrO₂ | 52 | 78 |
| Nb₂O₅ | 65 | 85 |
| V₂O₅ | 63 | 82 |
| SnO₂ | 5 | 8 |
| 2 wt % Nb₂O₅—Al₂O₃ | 65 | 81 |
| 2 wt % ZrO₂—Al₂O₃ | 64 | 80 |
| 2 wt % WO₃ Nb₂O₅ | 61 | 83 |
| 2 wt % ZrO₂ Nb₂O₅ | 60 | 80 |

As seen from Table 1, when Nb₂O₅, ZrO₂, or V₂O₅ is used as the carrier material, the circulation system can have a comparatively high conversion rate of catalyst. Nb₂O₅ and ZrO₂ as additives can also increase the conversion rate of catalyst. In other words, it is apparent that Nb₂O₅, ZrO₂, and V₂O₅ are very active and the reactivation of catalyst can increase the conversion rate of every catalyst. From the above result, it is known that the reactivation of catalyst is effective.

### Embodiment 2

By this Embodiment, the inventors evaluated the relationships of fuel supply pressure, exhaust pressure, conversion rate, valve control timing by the hydrogen supply device of FIG. 5. The inventors used 0.3 gram of platinum-carrying Nb₂O₅ catalyst which was prepared for Embodiment 1.

The evaluation steps comprises filling hydrogen supply device 21 with catalyst powder, mounting valves on inlet and outlet of hydrogen supply device 21, connecting a booster pump to the inlet valve for fuel supply and a vacuum pump to the outlet valve for gas exhaust (wherein these pumps are pressure-controllable), injecting methylcyclohexane at 100 μl/min in the helium gas flow (at 10 ml/min) at 250° C. for dehydrogenation, analyzing the liquid collected from the liquid hydrogen trap by GC-mass (GC-6500 by Simadzu Corp.), measuring the peak area of methylcyclohexane (98) and the peak area of toluene (92), and calculating the conversion rate (from methylcyclohexane to toluene) from the ratio of peak areas.

The inventors evaluated the relationship between fuel supply pressure and conversion rate under a test condition of 0.05 atm as the exhaust pressure and intermittent valve controlling for gas exhaust and fuel supply at intervals of 1 second. From this result, it is found that the conversion rate is almost constant at a fuel supply pressure of 300 atm or higher and that can be high enough at a fuel supply pressure of 2 to 300 atm. Similarly the inventors evaluated the relationship between exhaust pressure and conversion rate under a test condition of 10 atm as the fuel supply pressure and intermittent valve controlling for gas exhaust and fuel supply at intervals of 1 second.

From this result, it is found that the conversion rate is higher than the equilibrium conversion rate of methylcyclohxane when the exhaust pressure is 0.6 atm or lower and that the conversion rate is 80% or more when the exhaust pressure is 0.3 atm or lower. However, when the exhaust pressure is made lower than 0.01 atm, the exhaust facility becomes expensive. Therefore, the preferable exhaust pressure is 0.3 to 0.01 atm.

Next, the inventors evaluated the relationship between valve controlling and conversion rate under a test condition of 10 atm as the fuel supply pressure and 0.05 atm as the exhaust pressure. From the result, the inventors found that the conversion rate gradually went down as the fuel supply valve was opened longer but would not be affected so much by the open time of the exhaust valve. Specifically, the conversion rate is not affected by the exhausting time and the catalyst reactivation can be done successfully even when the exhausting time is short.

Meanwhile, the opening time of the fuel supply valve should preferably be as short as possible since the conversion rate would be reduced as the fuel supply valve is opened longer. Further, since the close time of the fuel supply valve affects the quantity of fuel per injection (pulse) applied to the catalyst layer, the fuel supply valve must be closed properly to effectively advance the reaction.

### Embodiment 3

This embodiment provides a turbine type exhaust device in the exhaust section of the hydrogen supply device.

The hydrogen supply system of FIG. 5 provides a cooler between the exhaust valve and the exhaust pump to separate gas (hydrogen) and dehydrogenate (liquid). Contrarily, the turbine type separator of FIG. 6 houses a cooler and an exhaust pump in the body to make it smaller and simpler. Further since this type of separator can suck and compress hydrogen gas by the exhaust pump, the hydrogen gas can be stored in an auxiliary tank or the like.

Next will be explained the turbine type separator of FIG. 6. Turbine type separator 30 mounted on the hydrogen supply system of this invention contains micro turbine 32 with turbine blades 33 in casing 31. The section equivalent to a diffuser of an ordinary micro turbine works as cooler 34 which is equipped with cooling pipe 35 through which a cooling medium flows. The turbine type separator is connected to the outlet of the exhaust valve on the hydrogen supply device with connection section 36. The turbine is driven by a power section, which is provided outside the system to work as a suction pump.

The power section can be an electric motor or engine. It is possible to connect one more turbine (the same turbine as that of FIG. 6) to the hydrogen supply device to feed back the exhaust gas (from the fuel cell or the hydrogen engine) to the turbine to produce power. When the exhaust valve opens, the micro turbine sucks the reaction gas into the turbine through suction port 37. The reaction gas is sent to cooling section 34 through a channel in the turbine and cooled there.

The dehydrogenate and unreacted fuel in the reaction gas are cooled to liquid and separated from hydrogen. The liquid and the hydrogen gas are taken out from the exit of the turbine. The liquid is sent to the waste liquid tank and the hydrogen gas is sent to a fuel cell or engine. The cooling section (34) can be so designed to compress the reaction gas into gas and liquid. In this case, the dehydrogenate is efficiently compressed into liquid and the hydrogen gas is compressed into high-pressure gas. The high-pressure hydrogen gas is stored in an auxiliary tank provided in the exit of the turbine type separator.

### Embodiment 4

This embodiment uses a hydrogen separation tube as the hydrogen supply device in the hydrogen supply system.

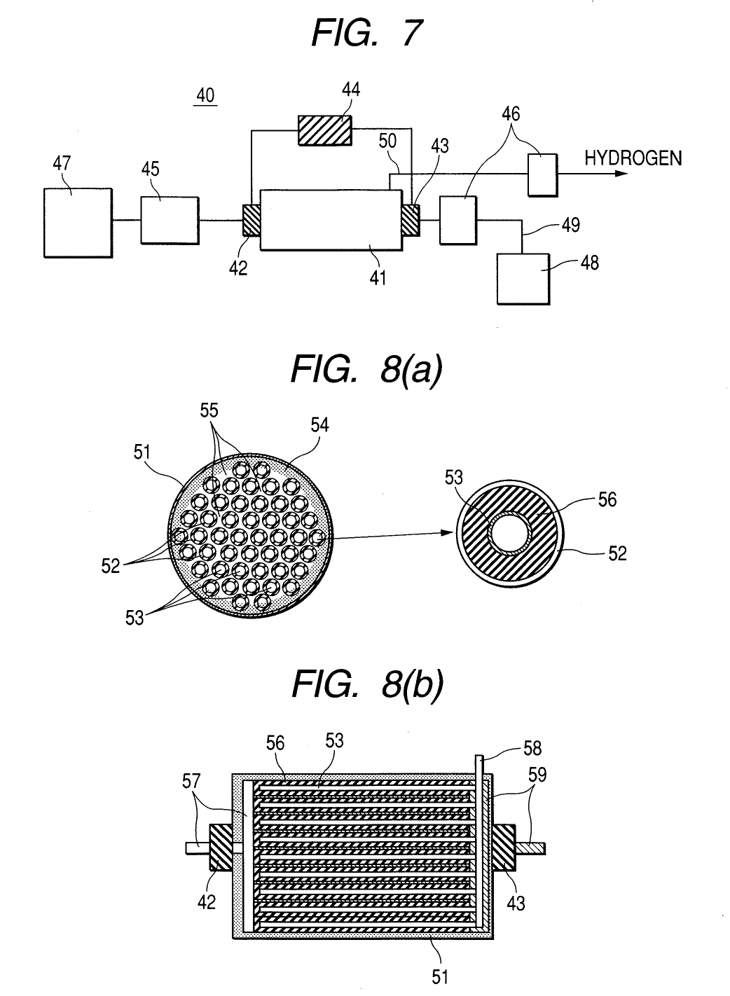

FIG. 7 shows the schematic configuration of a hydrogen supply system using a hydrogen separation tube. FIG. 8(a) and FIG. 8(b) respectively show sectional views of the hydrogen separation tube. The hydrogen supply device of FIG. 8 separates hydrogen by hydrogen separation tubes and supplies high-purity hydrogen gas. Hydrogen supply system 40 using hydrogen separation tubes comprises hydrogen supply device 41, fuel supply valve 42, exhaust valve 43, valve controller 44, booster pump 45 (for fuel supply), exhaust pump 46, fuel tank 47, waste liquid tank 48, waste liquid channel 49, and hydrogen channel 50. Although this hydrogen supply system is equipped with two exhaust pumps (for sucking the reaction gas and for separating hydrogen gas), the exhaust pump for sucking the reaction gas is not always required because the hydrogen gas has a high pressure in the hydrogen supply device and can be exhausted naturally when the exhaust valve is opened.

In FIG. 8, hydrogen supply device 51 using hydrogen separation tubes comprises heat insulating material 54 provided on the inner wall of hydrogen supply device 51, multiple reaction tubes 52 provided inside the tube of insulating material 54, and spaces 55 (among multiple reaction tubes 52) through which combustion gas flows. Each reaction tube 52 contains cylindrical hydrogen separation tube 53. The space between hydrogen separation tube 53 and the inner wall of reaction tube 52 is filled with catalyst layer 56.

Fuel is supplied into fuel channel 57 of the hydrogen supply device through fuel supply valve 42 and then sent to catalyst layer 56 of each reaction tube 52. Fuel is dehydrogenated into hydrogen and dehydrogenates by the catalyst. The generated hydrogen gas is sucked into hydrogen separation tube 53 by vacuum caused by exhaust pump 46 and collected to exhaust pump 46 through hydrogen collection tube 58. The dehydrogenates are sent to waste liquid tank 48 for storage through waste liquid channel 59.

The catalyst can be heated by a heater which is provided on the outer wall of the hydrogen supply device. It is also possible to heat the catalyst by burning part of the waste liquid with air in an external burner (which is not shown in drawings), supplying the hot gas to spaces (as combustion gas channel among multiple reaction tubes 52), and heating reaction tube 52 and catalyst 56.

The inventors produced hydrogen from methylcyclohxane by the above hydrogen supply system which contains five parallel-connected hydrogen supply devices of FIG. 8. Hydrogen gas of 250 liters per minute was obtained at 250° C. The conversion rate of methylcyclohxane was 96%.

### Embodiment 5

This embodiment uses a micro reactor which comprises hydrogen separating membranes as the hydrogen supply device in the hydrogen supply system.

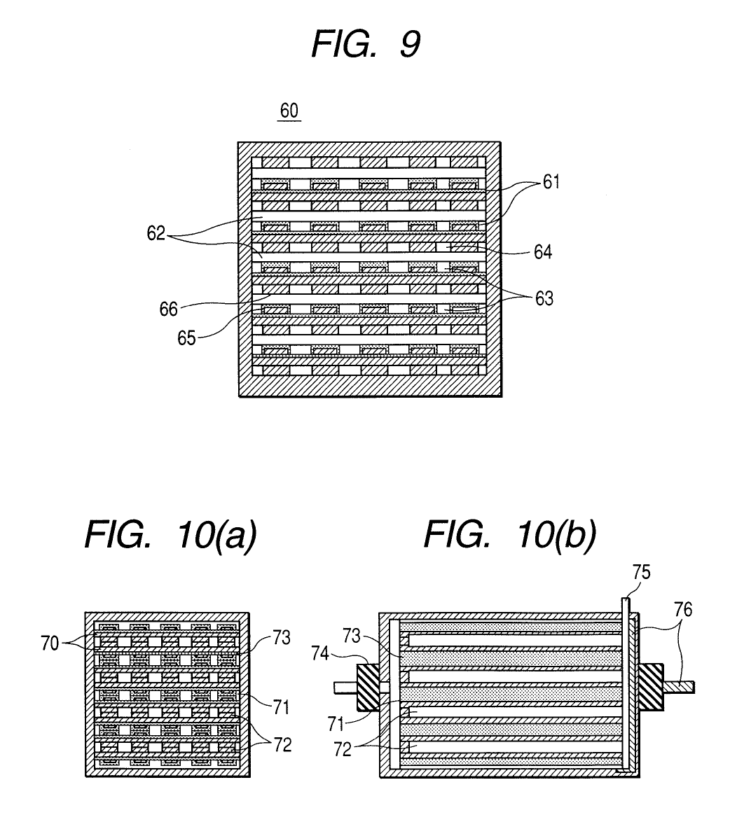

The hydrogen supply device of this embodiment uses a micro reactor, which comprises hydrogen separating membranes. The configuration of the hydrogen supply system of this embodiment is the same as that of FIG. 7. Hydrogen supply device 60 comprises a lamination of catalyst plates 61 and hydrogen separating membranes 62 which are alternately laminated and bonded by diffusion bonding as shown in FIG. 9. The micro reactor internally contains fuel channels 63 and hydrogen channels 64 which are formed etching. Catalyst plates 61 and hydrogen separating membranes 62 are laminated so that hydrogen separating membrane 62 may be sandwiched between catalyst 65 of catalyst plates 61 and metal surface 66. Fuel passes through fuel channel 63, touches catalyst 65, and generates hydrogen. Generated hydrogen is immediately separated by hydrogen separating membrane 62, collected by hydrogen channel 64, and sent to the external exhaust pump, fuel cell, or hydrogen engine.

The catalyst can be heated by a heater which is provided on the outer wall of the hydrogen supply device. It is also possible to heat the catalyst by burning part of the waste liquid with air in an external burner (which is not shown in drawings), supplying the hot gas to the outer wall of the micro reactor of FIG. 9. Usually micro reactors of FIG. 9 are used in a 4-column by 4-row matrix. To heat micro reactors, combustion gas is supplied to the spaces among micro reactors in a matrix or heaters are provided there. The whole micro reactor matrix (assembly) is covered with an insulating material for protection.

Next will be explained the details of the micro reactor of Embodiment 5.

The inventors prepared a micro reactor by etching a pure aluminum plate (heat conductivity: 250 watts/mK) of 1 mm thick as a highly-thermal conductive substrate by photolithography to form channel patterns, anodizing the surface of the etched aluminum plate, enlarging holes, and boehmite treatment the aluminum surface according to the method of Embodiment 5. Boehmite treatment comprises the steps of electro-polishing the patterned aluminum plate in a 85%-by-weight aqueous phosphoric acid solution at 60° C. and a current density of 20 A/dm² for 4 minutes, anodizing the electro-polished aluminum plate in 4%-by-weight aqueous oxalic acid solution at 30° C. and a voltage of 40 V for 7 hours to form a porous alumina layer of 100 μm thick on the patterned surface of the aluminum plate, dipping the processed plate in a 5%-by-weight aqueous phosphoric acid solution at 30° C. for 30 minutes to enlarge holes, dipping the plate in boiling water for 2 hours (for boehmite treatment), burning thereof at 250° C., applying 5%-by-weight platinum colloid solution (platinum colloid fabricated by Tanaka Kikinzoku Kogyou) to carry, and heating thereof at 250° C. With this, catalyst plate 61 was prepared.

Then, the inventors took the following steps: laminating the catalyst plates and the hydrogen separating membranes in a preset order, heating the laminated assembly at 450° C. for 5 hours in vacuum while pressing thereof at 10 kg/cm² to seal junctions, and finally connecting pipe to the assembly. With this, the hydrogen supply device was prepared.

The inventors produced hydrogen from methylcyclohxane by the above hydrogen supply system which contains five parallel-connected hydrogen supply devices of FIG. 8. Hydrogen gas of 250 liters per minute was obtained at 250° C. The conversion rate of methylcyclohxane was 96%.

### Embodiment 6

This embodiment uses a micro reactor which comprises catalyst unified with the hydrogen separating membranes prepared by Embodiment 5. The configuration of the hydrogen supply system of this embodiment is the same as that of FIG. 7. The hydrogen supply device of this embodiment is similar to that of FIG. 9, but the catalysts and hydrogen separating membranes are unified as shown in FIG. 10. Therefore, the micro reactor of this embodiment can separate hydrogen from both surfaces of the catalyst plate. This enables efficient hydrogen separation and quick reduction of partial hydrogen pressure. Further, this hydrogen supply device can supply hydrogen at lower temperature than the hydrogen supply device of Embodiment 6. The catalyst plates (70) unified with the hydrogen separating membranes in accordance with Embodiment 5 were laminated and junction-bonded by diffusion-bonding. Spaces formed in the micro reactor by etching work as fuel channels 71 and hydrogen channels 72. The catalyst plates were alternately laminated with their catalyst layers 73 faced each other. Fuel passes through fuel supply line 74, touches catalyst layers 73, and generates hydrogen. Generated hydrogen is immediately separated by hydrogen separating membrane, collected by hydrogen tube 75, and sent to the external exhaust pump, fuel cell, or hydrogen engine. The dehydrogenates are sent to the external waste liquid tank for storage through waste liquid recovery line 76.

The catalyst can be heated by a heater which is provided on the outer wall of the hydrogen supply device. It is also possible to heat the catalyst by burning part of the waste liquid with air in an external burner (which is not shown in drawings), supplying the hot gas to the outer wall of the micro reactor of FIG. 7. Usually micro reactors of FIG. 10 are used in a 4-column by 4-row matrix. To heat micro reactors, combustion gas is supplied to the spaces among micro reactors in a matrix or heaters are provided there. The whole micro reactor matrix (assembly) is covered with an insulating material for protection.

The inventors produced hydrogen from methylcyclohxane by the above hydrogen supply system which contains five parallel-connected hydrogen supply devices of FIG. 8. Hydrogen gas of 250 liters per minute was obtained at 220° C. The conversion rate of methylcyclohxane was 95%.

### Embodiment 7

This embodiment uses a reciprocation type hydrogen supply device which reactivates catalysts by heating.

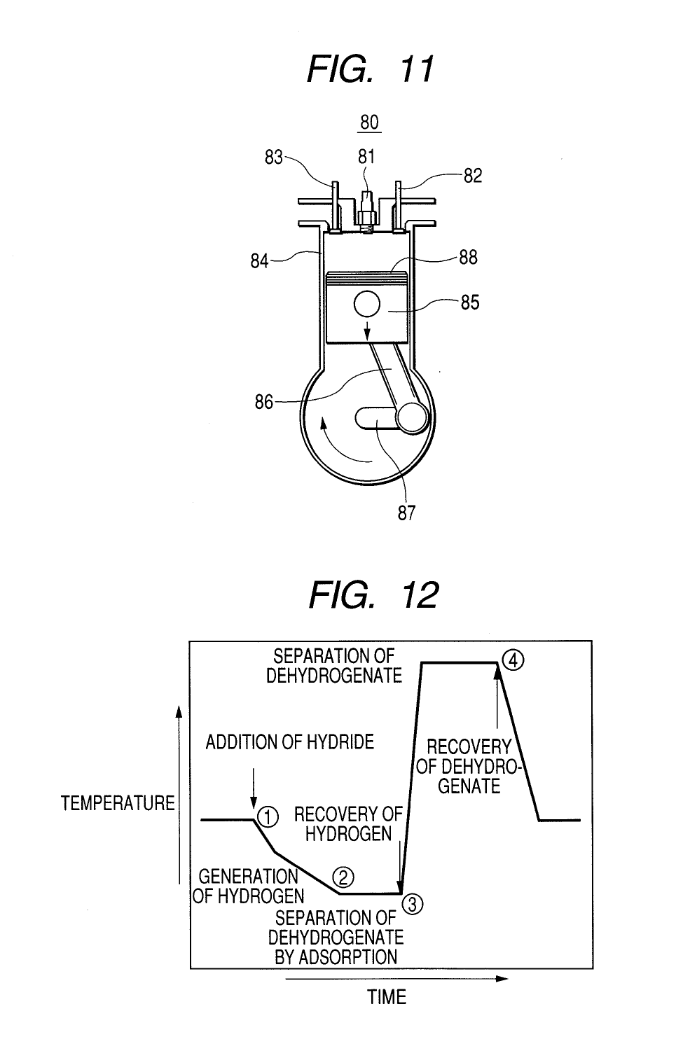

FIG. 11 shows the sectional view of a reciprocation type hydrogen supply device. Reciprocation type hydrogen supply device 80 comprises fuel supply nozzle 81, hydrogen exhaust valve 82, hydrocarbons exhaust valve 83, cylinder 84, piston 85, crank shaft 86, cone rod 87, and catalyst 88. Crank shaft 86 and cone rod 87 convert the rotational motion into the reciprocating motion to move piston 85. The temperature and pressure in cylinder 84 vary by the movement of piston 85 and operations of exhaust valves 82 and 83. When piston 85 goes up to compress with exhaust valves 82 and 83 closed, an adiabatic compression occurs and the inside of the cylinder becomes very hot. Consequently, the temperature of catalyst 88 goes up to 450° C.

If piston 85 goes up or down with either of exhaust valves 82 and 83 opened, the temperature and pressure in cylinder 84 do not vary. In other words, the temperature of catalyst can be controlled by opening or closing the exhaust valves while the piston is moving. FIG. 12 shows a cycle of dehydrogenation of organic hydride and reactivation at high temperature. When organic hydride is injected into the cylinder while the piston goes lowest and the catalyst is 250° C., an endothermic operation (due to evaporation of fuel and dehydrogenation) occurs and the temperature of the catalyst goes down. Not to let the temperature of the catalyst go down too much, the exhaust valves are closed and the piston is moved up to advance the reaction.

If the catalyst contains a carrier (e.g. activated carbon or zeolite), which easily adsorb hydrocarbons, the carrier can adsorb hydrocarbons when the catalyst temperature goes down. In this stage, hydrogen is not adsorbed by the carrier. Specifically, hydrogen is separated from dehydrogenates in the cylinder.

Next, the hydrogen exhaust valve is opened and the piston goes highest to exhaust hydrogen. When the piston starts to go down, the hydrogen exhaust valve is closed. The waste liquid valve is closed to prevent back-flow of waste liquid from the waste liquid tank and the hydrocarbons exhaust valve is opened. The waste liquid valve (not shown in drawings) is provided between the waste liquid tank and the hydrocarbons exhaust valve. Then, when the piston goes lowest (or when the cylinder space becomes greatest), the hydrocarbons exhaust valve is closed and the waste liquid valve is opened. In this status, the piston starts to go up (to compress the cylinder space) and an adiabatic compression occurs. The catalyst is heated up to 450° C. and completely frees adsorbed hydrogen. In this status, the cylinder space is about ¼ of the greatest cylinder space.

Here, the hydrocarbons exhaust valve is opened to discharge freed hydrocarbons as the piston moves up. Then, the waste liquid valve is closed and the hydrocarbons exhaust valve is still open. In this status, the piston moves down. When the piston goes lowest, the waste liquid valve is opened and the hydrocarbons exhaust valve is closed. At the same time, the fuel supply nozzle injects fuel into the cylinder space. The above steps are repeated to produce hydrogen from organic hydride easily at a high conversion rate. The inventors produced hydrogen from methylcyclohxane by the above hydrogen supply system which contains five parallel-connected hydrogen supply devices of FIG. 11. Hydrogen gas of 250 liters per minute was obtained. The conversion rate of methylcyclohxane was 95%.

This hydrogen supply device is effective to a reciprocation type hydrogen engine. The piston of the reciprocation type hydrogen supply device is driven using part of the rotational energy of the reciprocation type hydrogen engine. Further, the hydrogen engine need not require highly-pure hydrogen and can burn hydrogen which contains hydrocarbons.

### Embodiment 8

This embodiment is a power system comprising a fuel cell (of a solid polymer type) and the hydrogen supply device of this invention. This is a high-efficient compact power generation system unified with the hydrogen supply system of this invention.

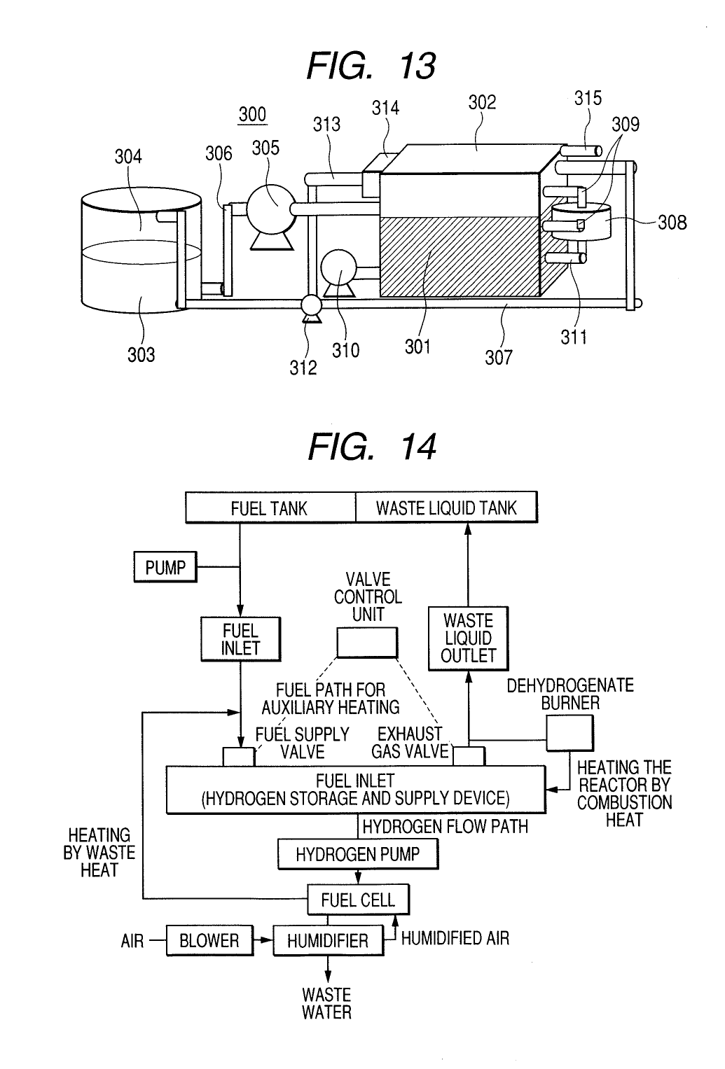

FIG. 13 shows a schematic external view of a power generation system comprising a solid polymer type fuel cell and a hydrogen supply device of this invention. FIG. 14 shows an operation flow of the power generation system. Power generation system 300 which uses a fuel cell hydrogen supply device 302 on solid polymer type fuel cell 301 and further comprises fuel tank 303, waste liquid tank 304, fuel pump 304, fuel supply line 306, waste liquid recovery line 307, turbine type exhaust pump 308, hydrogen line 309, air pump 310, fuel cell exhaust gas line 311, fuel supply pump 312 (for heating), fuel channel 313 (for heating), burner 314, and fuel exhaust gas line 315.

This system sends organic hydride (as fuel) to the hydrogen supply device by a pressure pump, sends part of waste liquid to the burner, burns it with air, and heats the hydrogen supply device. The system dehydrogenates fuel in the hydrogen supply device, sucks hydrogen by the turbine type exhaust pump, and sends it to the fuel cell. Further, the system sends part of the dehydrogenates (hydrocarbons) to the waste liquid tank through the waste liquid recovery line and the other part of the dehydrogenates to the burner by a pump provided in the waste liquid recovery line. By the way, this embodiment uses a valve-controlled hydrogen supply device which uses hydrogen separating membranes. The exhaust pump is provided only in the hydrogen channel side. Since the conversion rate of this system is very high, the products after the dehydrogenation are almost dehydrogenates. The dehydrogenates are exhausted naturally and cooled to a liquid for recovery.

This system requires two tanks: one for organic hydride and the other for dehydrogenated waste liquid (containing hydrocarbons). However, two tanks occupy too much installation areas. So the inventors made a single tank (400), which can store both fuel and waste liquid.

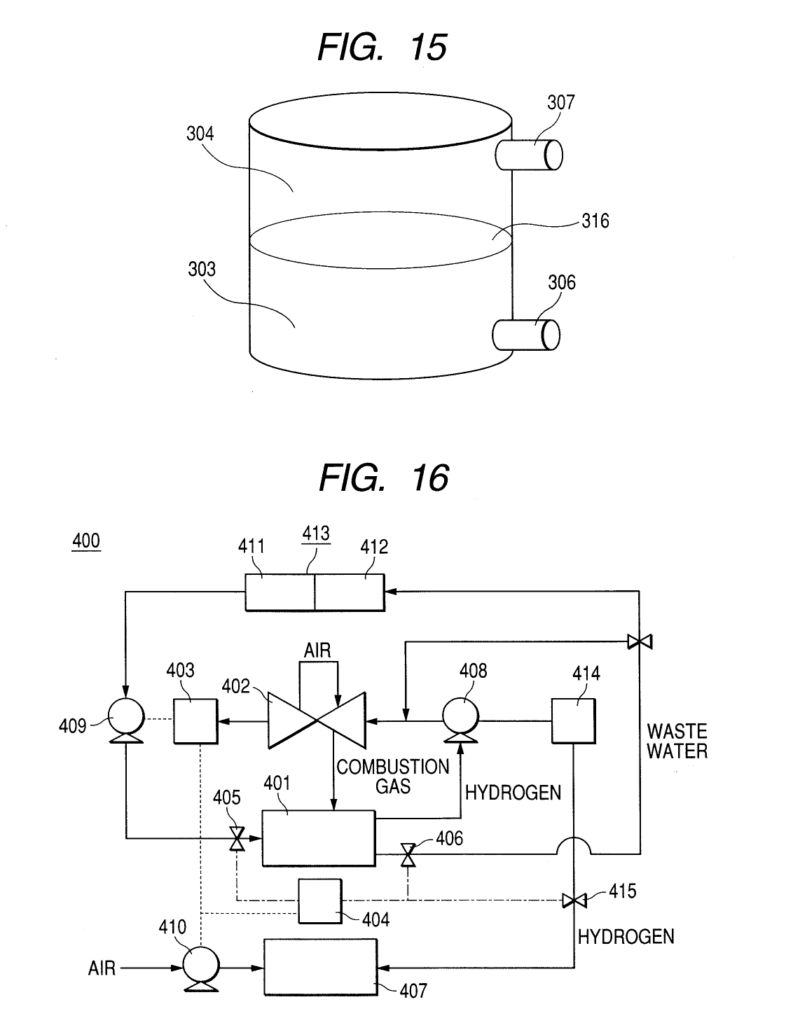

As shown in FIG. 15, the tank is divided into two by movable partition plate 316 to store fuel and waste liquid separately one above the other in the tank. Usually, lower part 303 of the tank stores fuel and upper part 304 stores waste liquid. Initially, fuel is supplied into the lower part (303) of the tank through fuel supply line 306. As the fuel keeps on coming into the lower part (303) of the tank, partition plate 316 goes up. To supply hydrogen for power generation, the fuel is sucked from the lower part (303) of the tank by fuel pump 305 through fuel supply line 306 and sent to the hydrogen supply device.

The waste liquid after dehydrogenation of the fuel is sent to the upper part (304) of the tank through waste liquid recovery line 307 and stored there. As the fuel is sucked and sent to the hydrogen supply device, partition plate 316 moves down and the upper part (304) of the tank becomes greater. With this, the waste liquid can enter the upper part (304) of the tank easily. The transition of tank capacities can be easily carried out since the density of the organic hydride is approximately equal to that of the waste liquid.

When the fuel is all consumed for supply of hydrogen and the upper part of the tank is filled with the waste liquid, the waste liquid is transferred to a tank lorry or the like for recovery and new fuel is supplied to the lower part of the tank. In this case, the fuel supply port and the waste recovery port of the tank lorry are respectively connected to the fuel inlet port and the waste outlet port of the tank for simultaneous fuel supply and recovery of waste liquid. As the fuel is supplied from the tank lorry to the lower part of the tank by a pump, partition plate 316 moves up and pushes out the waste liquid into the tank lorry simultaneously. The tank lorry also has a similar partition board to separate fuel from waste liquid. For quick and smooth fuel supply and recovery of waste liquid, the upper part of the tank lorry tank is for waste liquid and the lower part is for fuel.

With the above configuration, the tanks can be used efficiently for easy and smooth fuel supply and recovery of waste liquid.

The inventors supplied 1-methylcyclohexane as the fuel to the power generation system of FIG. 13 and generated power continuously. As described above, the power generation system of this invention can effectively use heat of water vapor (generated from the fuel cell) and hot waste liquid (generated from the hydrogen storage/supply device. Further, this system can use organic hydride efficiently and is available to car and home distributed power generators.

### Embodiment 9

This embodiment is an example of supplying waste heat to the hydrogen supply device from a turbine which uses dehydrogenates as fuel. FIG. 16 shows an operation flow of a turbine-combined system of this embodiment.

Turbine-combined system 400 sends waste heat to hydrogen supply device 401 from gas turbine 402 which burns part of dehydrogenates discharged from hydrogen supply device 401 to use the heat for the dehydrogenation.

Turbine-combined system 400 comprises hydrogen supply device 401, gas turbine 402, power generator 403, valve controller 404, fuel supply valve 405, exhaust valve 406, fuel cell 407, hydrogen pump 408, fuel supply pump 409, air pump 410, fuel/waste liquid tank 413 (containing both fuel tank 411 and waste liquid tank 412), auxiliary hydrogen tank 414, and hydrogen flow control valve 415.

This system supplies organic hydride from fuel tank 411 to hydrogen supply device 401 by fuel supply pump 409. Valve controller 404 controls the fuel supply into the reaction chamber of hydrogen supply device 401 through fuel supply valve 405. In the reaction chamber, the fuel is dehydrogenated by catalyst into hydrogen and dehydrogenates. Hydrogen is separated by hydrogen separating membranes. The dehydrogenates are discharged to waste liquid tank 412 through exhaust valve 406 and stored there. Part of the dehydrogenates is sent to gas turbine 402, mixed up with air, and burnt to turn the turbine of power generator 403. The generated power is used by fuel supply pump 409, air pump 410 of fuel cell and valve controller 404. The rotational power of gas turbine 402 is also used as a power source for hydrogen pump 408. Hydrogen separated by hydrogen separating membranes in hydrogen supply device 401 is sucked and compressed by hydrogen pump 408 and temporarily stored in auxiliary hydrogen tank 414. Hydrogen on demand is supplied to fuel cell 407 through hydrogen flow control valve 415, mixed up with oxygen which is supplied by air pump 410 to generate power.

As above described, this system efficiently supplies heat to the hydrogen supply device and utilizes power of auxiliary units (for heat supply and power generation). With this, the power generation efficiency of the system is increased.

### Embodiment 10

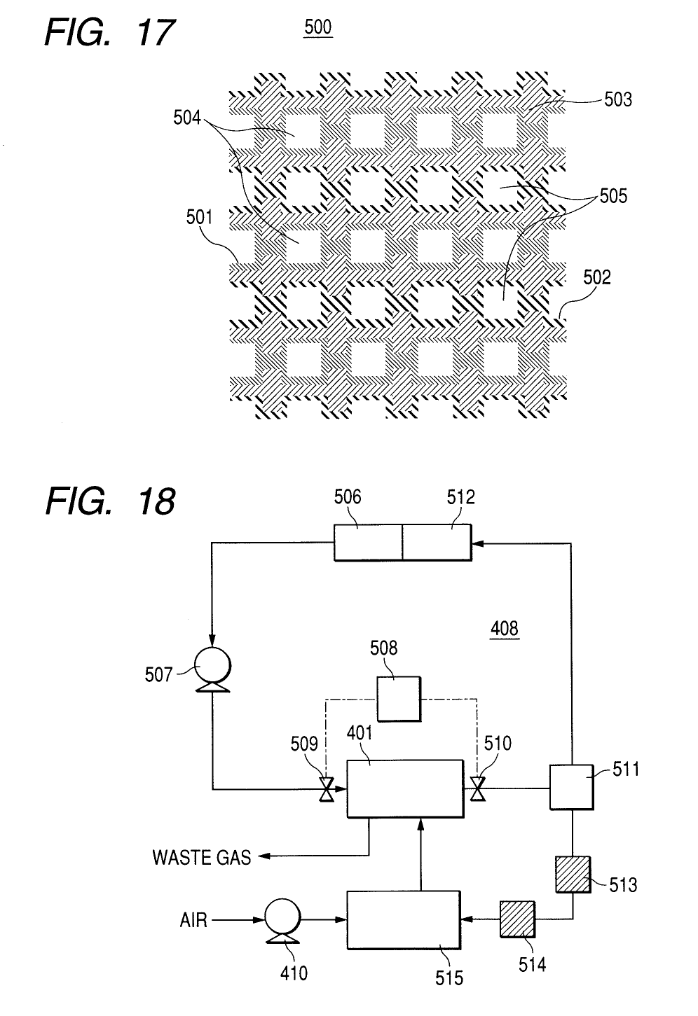

This embodiment is an example of hydrogen supply device unified with NOx removal catalyst which supplies heat from the exhaust gas of a hydrogen engine to the hydrogen supply device and cools the NOx removal catalyst by the endothermic reaction of the dehydrogenation of fuel. FIG. 17 shows a sectional view of the hydrogen supply device unified with NOx removal catalyst of Embodiment 10. FIG. 18 shows an operation flow of the system.

Hydrogen supply device 500 unified with NOx removal catalyst comprises catalyst plate 503 which has dehydrogenation catalyst 501 on one surface thereof and NOx removal catalyst on the other surface, fuel channels 504, and exhaust gas channels 505.

Organic hydride is supplied to hydrogen supply device 500 from fuel tank 506 by fuel pump 507. In this case, the quantity of fuel supply into fuel channel 504 through fuel valve 509 is controlled by valve controller 508. Hydrogen supply device 500 dehydrogenates fuel into hydrogen and dehydrogenates by dehydrogenation catalyst 502, exhausts the products through exhaust valve 510, separates the products into hydrogen gas and dehydrogenate liquid by gas-liquid separator 511, and stores the dehydrogenate liquid in waste liquid tank 512. The hydrogen gas is sucked and compressed by hydrogen pump 513 and temporarily stored in auxiliary hydrogen tank 514. Hydrogen gas on demand is supplied to hydrogen engine 515, mixed up and burnt with separately-supplied air.

The exhaust gas from hydrogen engine 515 is sent to exhaust gas channels 505 in hydrogen supply device 500, has NOx removed by NOx removal catalyst 502, and exhausted. NOx removal catalyst 502 is made of zeolite-based catalyst and can remove NOx steadily even in an oxygen-rich atmosphere. Conventionally, the NOx removal catalyst on a car is overheated, damaged and immediately loses it catalyst function. Contrarily, the NOx removal catalyst of hydrogen supply device 500 is in contact with the dehydrogenation catalyst which implements endothermic reaction on the rear side of a highly-thermal conductive substrate so that overheating of the NOx removal catalyst may be suppressed. This configuration can protect the zeolite catalyst from being overheated and damaged and assure the catalyst function.

Further, the hydrogen engine unlike the fuel cell does not require highly pure hydrogen and the hydrogen separating membranes may not always be required. Even when the hydrogen gas separated by the gas-liquid separator contains a little hydrocarbons can be normally burnt in the engine. In some cases, the hydrogen gas containing a little hydrocarbons may facilitate combustion control. This can make the system more simplified.

This kind of hydrogen supply device 500 unified with NOx removal catalyst is available to stationary and movable distributed power supplies. This system enables provision of power generators and cars which reduce exhaust CO₂. By the way, the configuration of hydrogen supply device 500 is not limited to that of FIG. 18. Hydrogen supply device 500 can have any configuration as long as it contains a hydrogen supply catalyst and a NOx removal catalyst which are spaced from each other. For example, such a configuration can be a cylindrical tube, which has a hydrogen supply catalyst on the inner wall of the tube and a NOx removal catalyst on the outer wall thereof.

What is claimed is:

1. An engine system having a hydrogen combustion engine comprising:
a hydrogen supply device for generating hydrogen by dehydrogenation reaction of a dehydrogenation catalyst from a hydrogen storage material that chemically stores hydrogen and supplying the hydrogen to the hydrogen combustion engine; and
a NOx purification catalyst for purifying exhaust gas from the engine,
wherein heat in the exhaust gas from the hydrogen combustion gas is supplied to the hydrogen supply device, and
wherein the NOx purification catalyst is cooled by enthermal reaction of the dehydrogenation reaction of the hydrogen supply device.

2. The engine system according to claim 1, which further comprises a heat conductive catalyst plate one face of which is provided with the dehydrogenation catalyst and the other face is provided with the NOx purification catalyst.

3. The engine system according to claim 1, wherein the catalyst plate has a first flow passage for flowing hydrogen storage material on the face provided with the dehydrogenation catalyst, and a second flow passage for flowing the exhaust gas of the hydrogen combustion engine.

4. The engine system according to claim 1, wherein the NOx purification catalyst is a zeolite group catalyst.

5. The engine system according to claim 1, which further comprises:
a fuel inlet valve disposed at a fuel supply port of the fuel inlet device;
an exhaust outlet valve disposed at an exhaust gas port of the hydrogen supply device;
a pump for exhausting reaction gas from the hydrogen supply device; and
a valve control unit for controlling timing to open and close the fuel inlet valve and the exhaust outlet valve so as to exhaust gas at a pressure lower than that at the time of hydrogenation generation.

6. The engine system according to claim 1, which further comprises a heating device for heating and regenerating the dehydrogenation catalyst.

7. The engine system according to claim 1, wherein the hydrogen storage material is an aromatic compound selected from the group consisting of benzene, toluene, xylene, mesitylene, naphthalene, methylnaphthalene, anthracene, biphenyl, phenanthrene and combinations thereof.

8. The engine system according to claim 1, wherein the dehydrogenation catalyst comprises a metal catalyst and a carrier supporting the metal catalyst, the metal catalyst being a member selected from the group consisting of nickel, palladium, platinum, rhodium, iridium, ruthenium, molybdenum, rhenium, tungsten, vanadium, osmium, chromium, cobalt, iron and combinations thereof, and the carrier being a member selected from the group consisting of alumina, zinc oxide, silica, zirconium oxide, diatomite, niobium oxide, vanadium oxide, activated carbon, zeolite, antimony oxide, titanium oxide, tungsten oxide, iron oxide and combinations thereof.
